(19) United States
(12) Patent Application Publication
(10) Pub. No.: US 2016/0249408 A1
(43) Pub. Date: Aug. 25, 2016

(54) METHOD AND SYSTEM TO MANAGE RADIO RESOURCE CONTROL (RRC) CONNECTION IN MULTI-SIM USER EQUIPMENT (UE)

(71) Applicant: Samsung Electronics Co., Ltd., Gyeonggi-do (KR)

(72) Inventors: Balaji Srinivasan THIRUVENKATACHARI, Bangalore (IN); Ashish Kumar GUPTA, Bangalore (IN); Shrinath Ramamoorthy MADHURANTAKAM, Bangalore (IN)

(73) Assignee: Samsung Electronics Co., Ltd.

(21) Appl. No.: 15/052,412

(22) Filed: Feb. 24, 2016

(30) Foreign Application Priority Data
Feb. 24, 2015 (IN) 879/CHE/2015

(51) Int. Cl. H04W 76/06

(52) U.S. Cl. CPC H04W 76/06

(57) ABSTRACT

Methods and apparatuses are provided for releasing a radio resource control (RRC) connection in a wireless communication network. A user equipment (UE) monitors the RRC connection. The UE performs a local RRC connection release when the UE has failed to receive an RRC connection release message from a network based on a predefined criterion. The RRC transmits an RRC connection release indication to the network. A first subscriber identity module (SIM) is transitioned from an RRC connected mode to an RRC idle mode.

### PRIORITY

This application claims priority under 35 U.S.C. §119(a) to an Indian patent application filed in the Indian Property Office on Feb. 24, 2015 and assigned Serial No. 879/CHE/2015, the content of which is incorporated herein by reference.

### BACKGROUND

1. Technical Field

The embodiments herein relate to wireless communication, and more particularly, to a method and system for managing a Radio Resource Control (RRC) connection in a multi-subscriber identity module (multi-SIM) user equipment (UE).

2. Description of Related Art

Dual/Multi-SIM UEs allow for communication through at least two different networks/numbers. These dual/multi-SIM UEs are useful for users that maintain two or more numbers for personal and professional use. Further, the dual/multi-SIM UEs are also useful when any one of the SIMs is non-functional.

Dual/Multi-SIM UEs may be classified into three categories, based on functionality and network access: dual SIM shift devices, dual SIM active devices, and dual SIM dual standby (DSDS) devices.

A dual SIM shift device is the basic model of a dual SIM UE, in which both SIMs can be inserted into the device, but a user can use only one SIM at a time. While using one SIM, the other remains inactive, and thus, remains in a switched off mode.

A dual SIM active device allows both SIMs to be active simultaneously. The dual SIM active device has two built-in radio frequency (RF) transceivers, one of which may support 2G and the other of which may support 2G/3G. The two transceivers allow a user to receive calls and messages at both the SIMs simultaneously. The major drawback of dual SIM active devices is that they consume more battery since both SIMs are in the active mode, and since dedicated RF transceivers are used for each SIM.

The DSDS device allows both SIMs to be active at any time, but only has a single transceiver. Therefore, when one SIM is receiving a call, the other SIM cannot simultaneously receive a call. The DSDS device can have two different stacks for the two SIMs to communicate with their respective networks. The SIMs can have different frequencies, and the RF transceiver can adjust the receiving frequency of the device according to the frequency of the network of the SIM. Hence while an RF is being used by stack-2, for example, 2G, there is possibility that stack-1, for example, LTE, misses an RRC connection release message from the network. After sending the RRC connection release message, the network removes the context of the UE and considers the UE to be in an idle mode. However, if the UE has not received the RRC connection release message, the UE will remain in an RRC connected mode.

### SUMMARY

The various embodiments of the present disclosure have been made to address at least the above problems and/or disadvantages and to provide at least the advantages described below. Accordingly, an aspect of the present disclosure provides a method for managing an RRC connection in multi-SIM UE in a wireless communication network.

According to an embodiment, a method for releasing an RRC connection by a UE in a wireless communication network is provided. The method includes monitoring the RRC connection; performing a local RRC connection release operation when the UE has failed to receive an RRC connection release message from a network based on a predefined criterion; transmitting an RRC connection release indication message to the network; and transitioning a first SIM from an RRC connected mode to an RRC idle mode.

According to another embodiment, a UE in a wireless communication network is provided. The UE includes a processor configured to: monitor the RRC connection; perform a local RRC connection release operation when the UE has failed to receive an RRC connection release message from a network based on a predefined criterion; transmit an RRC connection release indication message to the network; and transit a first SIM from an RRC connected mode to an RRC idle mode.

According to another embodiment, a system-on-chip is provided for releasing an RRC connection in a wireless communication network. The system-on-chip is configured to: monitor the RRC connection; perform a local RRC connection release operation when the UE has failed to receive an RRC connection release message from a network based on a predefined criterion; transmit an RRC connection release indication message to the network; and transit a first SIM from an RRC connected mode to an RRC idle mode.

According to another embodiment, an article of manufacture is provided for releasing an RRC connection in a wireless communication network, which includes a machine readable medium containing one or more programs which when executed implement the steps of: monitoring the RRC connection; performing a local RRC connection release operation when the UE has failed to receive an RRC connection release message from a network based on a predefined criterion; transmitting an RRC connection release indication message to the network; and transitioning a first SIM from an RRC connected mode to an RRC idle mode.

### BRIEF DESCRIPTION OF THE DRAWINGS

The above and other aspects, features, and advantages will be more apparent from the following detailed description when taken in conjunction with accompanying drawings in which:

FIG. 1 is a flowchart illustrating a method of managing an RRS connection release message missing from a SIM by the network;

FIG. 2 is a flowchart illustrating a method for managing an RRC connection in a multi-SIM UE, according to an embodiment of the disclosure;

FIG. 3 is a flowchart illustrating a method for managing an RRC connection in a multi-SIM UE, according to an embodiment of the disclosure; and

FIG. 4 is a block diagram illustrating a UE, according to an embodiment of the disclosure; and

FIG. 5 is a block diagram illustrating a computing system, according to an embodiment of the present invention.

### DETAILED DESCRIPTION

Embodiments are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

Herein, reference may be made to “an”, “one”, or “some” embodiment(s). This does not necessarily imply that each such reference is to the same embodiment(s), or that the feature only applies to a single embodiment. Single features of different embodiments may also be combined to provide other embodiments.

As used herein, the singular forms “a”, “an”, and “the” are intended to include the plural forms as well, unless expressly stated otherwise. It will be further understood that the terms “includes”, “comprises”, “including”, and/or “comprising”, when used herein, specify the presence of stated features, integers, steps, operations, elements, and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meanings as those commonly understood by one of ordinary skill in the art to which this disclosure pertains. It will be further understood that terms, such as those defined in commonly used dictionaries, should be interpreted as having a meaning that is consistent with their meaning in the context of the relevant art, and will not be interpreted in an idealized or overly formal sense unless expressly so defined herein.

During use of a DSDS device, even though only one SIM is active and can access the RF transceiver, co-existence between the SIMs is expected. For example, when SIM 1 is sending data over an RF transceiver RRC connection to network operator 1, while SIM 2 is in an IDLE mode, during a certain time period, operator 2 of SIM 2 can send downlink data pages to the UE. The paging data sent by the operator should not be missed, since the paging data helps the SIM of the UE to understand the current situation of the SIM, any incoming mobile terminating (MT) call or MT message and the like. Thus, the MT call or message has a higher precedence than the data. Therefore, the UE can create autonomous gaps to enable the SIM 2 to perform the required actions when the SIM 1 maintains an RRC connection and the SIM 2 remains in the IDLE mode. The SIM 1 can resume receiving data on the RRC connection once the SIM 2 hands over the RF transceiver upon finishing the MT call or message.

However, when an RRC connection remains between one of the SIMs and the respective network operator, while the other SIM is using RF resources, the SIM sends an RRC RELEASE message to the network. Since the RF resources were being used by the other SIM, and since the RRC RELEASE message does not include an acknowledgement message, the network operator will be unaware that the SIM is requesting the connection release and the SIM will expect that the network operator has received the connection release message. Since the network has not received the RRC RELEASE message, the network continues to provide the RF resources to the SIM, keeping remaining SIMs on hold. This situation can create deadlock for resource utilization, and can consume more battery power of the UE.

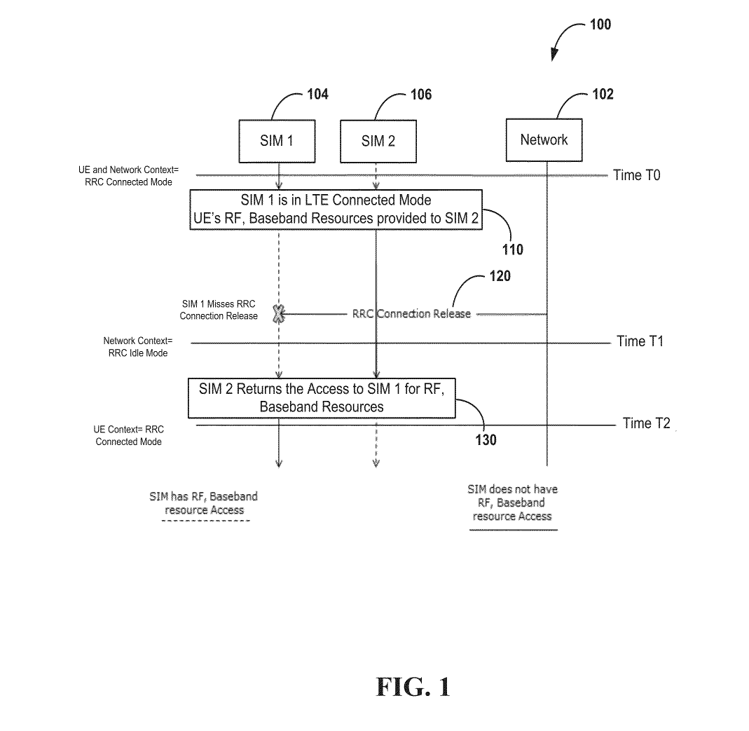

FIG. 1 is a flowchart illustrating a method of managing an RRC connection release message missing from a SIM by the network. According to FIG. 1, a system 100 includes a network 102, a SIM 1 104, and a SIM 2 106. Initially, at time T0, the SIM 1 104 establishes a connection with the network 102 using an RRC connection. The UE is uses a long term evolution (LTE) connection from the SIM 1 104 to access data, and uses an RF baseband for data communication. The SIM 2 106 is in an IDLE mode. After a certain time period, the SIM 2 106 receives paging information from the network operator. In order to allow the SIM 2 106 to receive paging information, in step 110, the SIM 1 104 holds the RRC connection with the network 102, but provides an RF bandwidth and baseband resources to the SIM 2 106.

While the SIM 2 106 is still accessing the RF bandwidth, the network 102 may wish to release the RRC connection. An RRC RELEASE message is sent from the network 102 to the SIM 1 104, in step 120. However, since the RF bandwidth is being used by the SIM 2 106, the SIM 1 104 misses the RRC RELEASE message. Thus, at time T1, the RRC connection of the SIM 1 104 is maintained with the network 102. In step 130, the SIM 2 106 returns the RF bandwidth and other resources to the SIM 1 104, and returns to the IDLE mode. The SIM 1 104 receives the RF bandwidth and other resources so that it may return to a connected mode. At time T2, the SIM 1 104 remains connected with the network 102 after the network 102 has sent out the RRC RELEASE message for releasing the connection. Therefore, uncertainty exists between the SIMs and the network, thereby causing a deadlock for resources, and resulting in greater battery power consumption.

The various embodiments herein disclose a method of managing an RRC connection in a multi-SIM UE. Specifically, the UE performs RRC connection monitoring. The UE monitors whether an RRC connection is active or not in order to identify whether any SIM of the multi SIMs is active and in a connected mode. The UE performs local release upon detecting a missed RRC Connection release based on predefined criteria.

Further, the method includes a step of transmitting the RRC connection release indication to a network, if the UE failed to receive the RRC connection release message from the network based on a predefined criterion. During monitoring, the UE identifies that one of the SIMs has an RRC connection with the network. The UE can determine whether any one of the predefined criteria exists. If the UE fails to receive the RRC connection release message from the network based on a predefined criterion, the UE transitions to an RRC idle mode. The UE transmits an RRC connection release indication to the network. In an embodiment, the predefined criteria can include, but is not limited to, expiry of an RF unavailability monitoring timer value in a connected mode, downlink data reception inactivity for a preset time, reception of a paging message from the network while the UE is in the RRC connected mode, and the like.

Further, the UE may transition from an RRC connected mode to an RRC idle mode locally, and may transmit the RRC connection release message to the network. The UE switches from a connected mode to the idle mode, and thereby releases resources and saves battery power.

Embodiments are described considering the above-described pre-defined criteria, based on which the RRC connection release process varies.

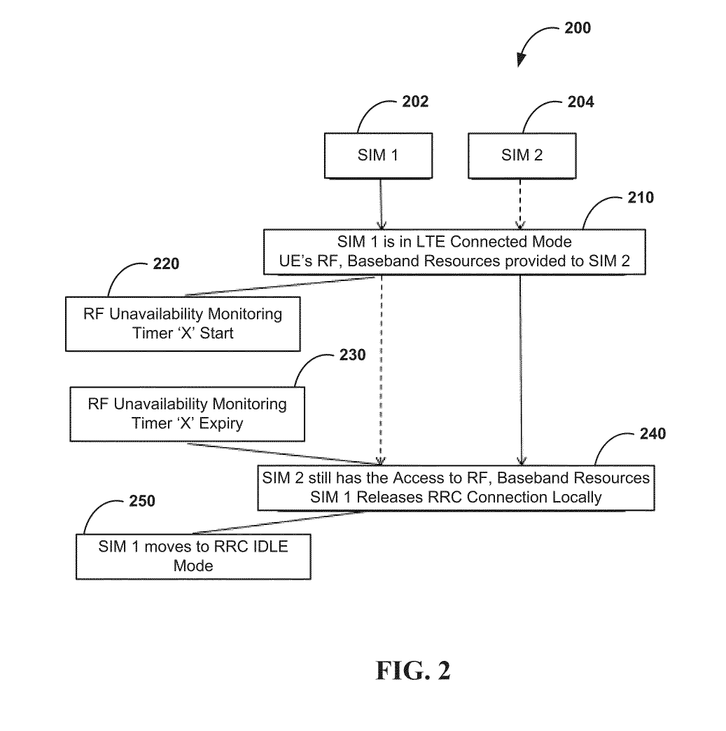

FIG. 2 is a flowchart illustrating a method for managing an RRC connection in a multi-SIM UE, according to an embodiment of the disclosure. Referring to FIG. 2, an RRC connected multi-SIM UE is released based on a criterion relating to expiry of an RF unavailability monitoring timer in a connected mode. A system 200 includes a SIM 1 202 and a SIM 2 204 of the dual SIM UE. Initially, the SIM 1 202 and the SIM 2 204 are in an idle mode, and therefore, are not consuming any of the resources of the UE. In step 210, the SIM 1 202 of the UE enters into an LTE connected mode, as illustrated with a solid line, and thus, obtains available resources for connection, while the SIM 2 204 remains in the idle mode, as illustrated with a dotted line. In an embodiment, the resources provided to the SIM of the UE can be, but are not limited to, an RF of the UE, baseband resources, and the like.

Within a particular time period, the SIM 2 204 receives information for its network. Since the resources are allocated to the SIM 1 202, the SIM 2 204 is provided with the UE's RF and baseband resources that are actually allocated to the SIM 1 202. Even though the resources are allocated to the SIM 1 202, the resources are being used by the SIM 2 204. In an embodiment, the resources are allocated to the SIM that is in the idle mode from the SIM that is in the connected mode, during one or more of, but not limited to, the following situations: mobile originating (MO)/mobile terminating (MT) calls; MO/MT messages; paging messages; and the like. When the RF and baseband resources are allocated to the SIM 2 204, in step 220, the UE initiates monitoring of the status of the SIM 1 202. Monitoring the status of the SIM 1 202 includes starting an RF unavailability monitoring timer. In an embodiment, the resource unavailability timer is calculated from N310 and T310 RLM monitoring values provided by the network. In another embodiment, any other type of the resource unavailability timer can be used to measure resource unavailability for the SIM.

The resource unavailability timer is set with a predetermined value, indicating that the SIM must receive the resources back within the set time. In an embodiment, the UE is configured to set up a value of the timer. In another embodiment, the network is configured to set up a value of the timer and transmit the value of the timer to the UE.

In step 230, the RF unavailability monitoring timer expires, and thus, the UE determines that the SIM 1 202 has not received the resources within the expiry time of the resource unavailability timer. Thus, the UE determines that the SIM 2 204 still has the access to the RF and baseband resources.

Upon determining that the SIM 2 204 of the UE still has the access to the RF and baseband resources, in step 240, the UE transitions to an RRC idle mode, and may transmit an RRC connection release message to the network for releasing the resources from the SIM 1 202. Upon sending the RRC connection release message and in step 250, the SIM 1 202 instantly enters an idle mode.

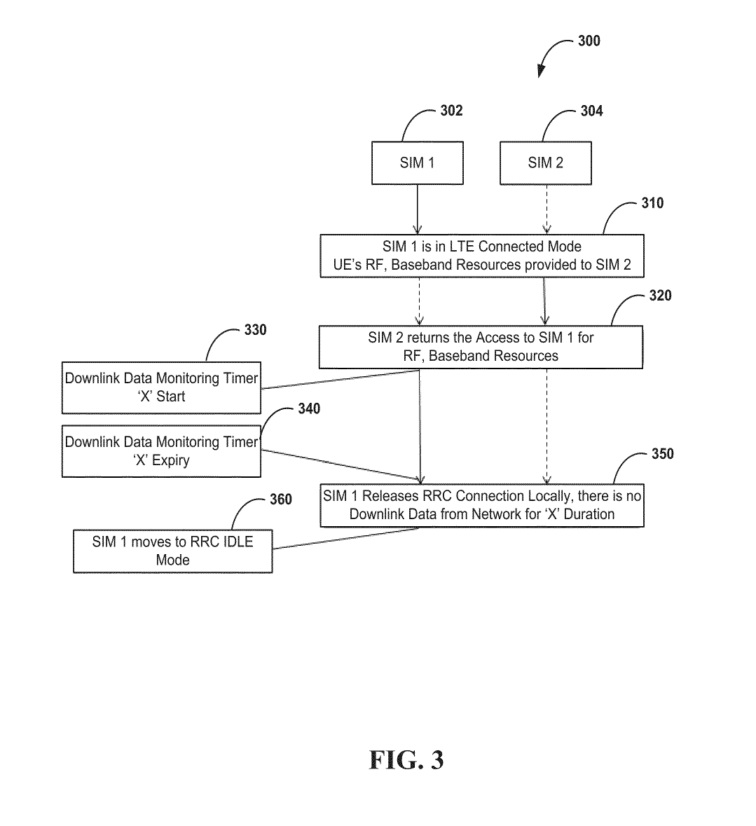

FIG. 3 is a flowchart illustrating a method for managing an RRC connection in multi-SIM UE, according to an embodiment. According to FIG. 3, an RRC connected multi-SIM UE is released based on a criterion relating to downlink data reception inactivity for a preset time. A system 300 includes a SIM 1 302 and a SIM 2 304 of a dual SIM UE. Initially, the SIM 1 302 and the SIM 2 304 are in an idle mode, and therefore, are not consuming any of the resources of the UE.

In step 310, the SIM 1 202 of the UE enters into an LTE connected mode, illustrated in FIG. 3 with a solid line, and thus, obtains available resources for connection. The SIM 2 304 remains in an idle mode, illustrated in FIG. 3 with a dotted line.

During a particular time period, the SIM 2 304 receives information for its network. Since the resources are allocated to the SIM 1 302, the SIM 2 304 is provided with the UE's RF and baseband resources that are actually allocated to the SIM 1 302. Thus, even though the resources are allocated to the SIM 1 302, the resources are being used by the SIM 2 304, as described above with respect to FIG. 2.

In step 320, the SIM 2 304 completes the function and returns access to the resources back to the SIM 1 302. Once the resources are returned back to the SIM 1 302, in step 330, the UE monitors the RRC connection by initiating a downlink data monitoring timer. The timer measures the amount of time taken to receive downlink data from the network. The timer for monitoring the downlink data can be the same as an RF unavailability monitoring timer, as described above with respect to FIG. 2.

In step 340, after a predetermined time, the timer for downlink data monitoring expires, indicating that the SIM 1 302 of the UE does not receive any downlink data from the network. Upon determining that the SIM 302 does not receive any downlink data within the predetermined time, the UE determines that the RRC connected mode status of the SIM 1 302 is not known to the network.

In step 350, the UE locally releases the RRC connection, and may transmit an RRC connection release message to the network for releasing of the resources from the SIM 1 302.

Upon sending the RRC connection release message, the UE does not wait for an acknowledgement or response from the network, and the SIM 1 302 instantly enters an idle mode, in step 360.

According to another embodiment, an RRC connected multi-SIM UE releases an RRC connection based on a criterion relating to reception of paging message from the network. A SIM 1 of the UE can be provided with the resources, while the SIM 2 is in an idle mode.

Upon identifying that the resources are to be allocated to the SIM 2, the UE locally releases an RRC connection, and may transmit an RRC connection release message to the network for releasing the resources allocated to the SIM 1. Upon sending the RRC connection release message, the UE does not wait for an acknowledgement or response from the network, and the SIM 1 is instantly entered into the idle mode.

The present embodiments are described with respect to a dual SIM UE. Embodiments may also be implemented in a UE with two or more SIMs. For example, the UE can be embodied as any wireless communication device, including, but not limited to, a mobile phone, a laptop, a personal digital assistant (PDA), a tablet, and the like.

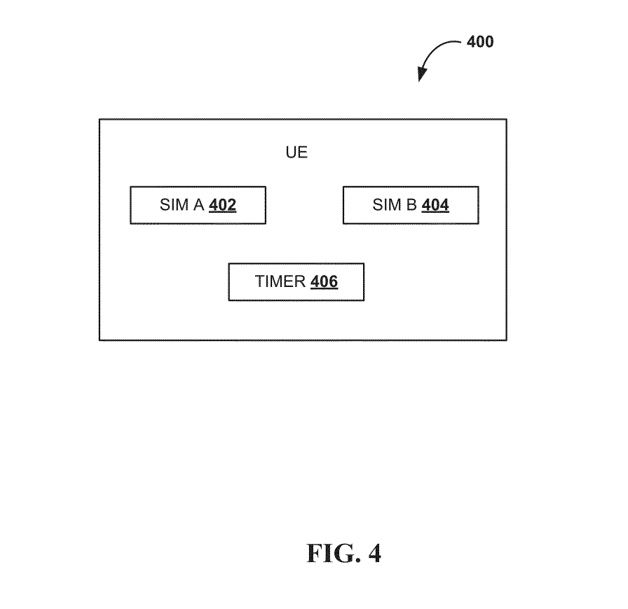

FIG. 4 is a block diagram illustrating a UE, according to an embodiment of the disclosure. Referring to the FIG. 4, a UE 400 includes two SIMs, SIM A 402 and SIM B 404, and a timer 406. In an embodiment, both SIM A 402 and SIM B 404 can be connected to the same network. In another embodiment, SIM A 402 and SIM B 404 of the UE 400 can be connected to different networks. According to an embodiment, the timer 404 can be embodied as, but is not limited to, a resource unavailability timer, a downlink data monitoring timer, and the like.

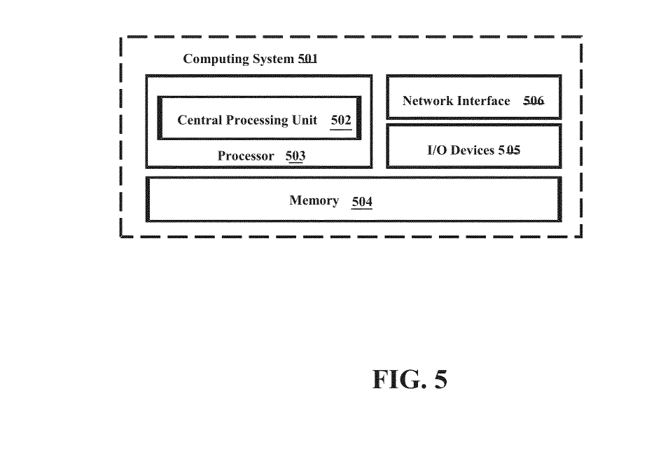

FIG. 5 is a block diagram illustrating a computing system, according to an embodiment of the present invention. A computing system 501 includes a processor 503, a memory 504, input/output (I/O) devices 505, and a network interface 506, coupled via a computer bus or alternate connection arrangement.

It is to be appreciated that the processor 503 is intended to include any processing device, such as, for example, one that includes a central processing unit (CPU) 502 and/or other processing circuitry. It is also to be understood that the term “processor” may refer to more than one processing device and that various elements associated with a processing device may be shared by other processing devices. The memory 504 includes a memory associated with the processor 503 or the CPU 502, such as, for example, random access memory (RAM), read only memory (ROM), a fixed memory device (e.g., hard drive), a removable memory device, flash memory, etc.

In addition, the I/O devices 505 include, for example, one or more input devices for entering information into the processing unit, and/or one or more output devices for outputting information associated with the processing unit.

Still further, the network interface 506 includes, for example, one or more transceivers to permit the computer system to communicate with another computer system via an appropriate communications protocol. This may provide access to computer systems that provide information regarding timing reports of signal paths or physical layouts of integrated circuit devices.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

The present invention may be utilized in conjunction with the manufacture of integrated circuits, chip sets, or system-on-chips (SoCs). Regarding integrated circuits in general, a plurality of identical die are typically formed in a repeated pattern on a surface of a semiconductor wafer. Each die may include other structures or circuits. The individual die is cut or diced from the wafer, then packaged as an integrated circuit. One skilled in the art would know how to dice wafers and package die to produce integrated circuits. Integrated circuits so manufactured are considered part of this invention.

While the present disclosure has been shown and described with reference to certain embodiments thereof, it will be understood by those skilled in the art that various changes in form and detail may be made therein without departing from the spirit and scope of the present disclosure as defined by the appended claims

What is claimed is:

1. A method for releasing a radio resource control (RRC) connection by a user equipment (UE) in a wireless communication network, the method comprising:
monitoring the RRC connection;
performing a local RRC connection release operation when the UE has failed to receive an RRC connection release message from a network based on a predefined criterion;
transmitting an RRC connection release indication message to the network; and
transitioning a first subscriber identity module (SIM) from an RRC connected mode to an RRC idle mode.

2. The method of claim 1, wherein monitoring the RRC connection comprises:
when the first SIM is in the RRC connected mode and a second SIM is in the RRC idle mode, receiving information for a network of the second SIM; and
allocating a radio frequency (RF) and baseband resources from the first SIM to the second SIM.

3. The method of claim 2, wherein the predefined criterion comprises expiry of an RF unavailability monitoring timer in the RRC connected mode.

4. The method of claim 3, wherein performing the local RRC connection release operation and transmitting the RRC connection release indication message comprises:
determining that the first SIM does not receive the RF and baseband resources within the expiry of the RF unavailability monitoring timer; and
transmitting the RRC connection release indication message to the network.

5. The method of claim 3, further comprising:
setting a value of the RF unavailability monitoring timer.

6. The method of claim 3, further comprising:
receiving a value of the RF unavailability monitoring timer from the network.

7. The method of claim 2, wherein the predefined criterion comprises downlink data reception inactivity for a preset time.

8. The method of claim 7, wherein monitoring the RRC connection further comprises receiving an access message requesting access to the RF and the baseband resources from the second SIM, and
wherein transmitting the RRC connection release indication message comprises determining that the RRC connected mode of the first SIM is unknown to the network when downlink data reception is inactive for the preset time.

9. The method of claim 2, wherein the predefined criterion comprises reception of a paging message from the network while the UE is in the RRC connected mode.

10. The method of claim 9, wherein transmitting the RRC connection release indication message comprises determining that the RF and the baseband resources are to be allocated to the second SIM upon reception of the paging message, and transmitting the RRC connection release indication message upon determining that the RF and the baseband resources are to be allocated to the second SIM.

11. A user equipment (UE) in a wireless communication network, the UE comprising:
a processor configured to:
monitor the RRC connection;
perform a local radio resource control (RRC) connection release operation when the UE has failed to receive an RRC connection release message from a network based on a predefined criterion;
transmit an RRC connection release indication message to the network; and
transit a first subscriber identity module (SIM) from an RRC connected mode to an RRC idle mode.

12. The UE of claim 11, wherein the processor is further configured to:
when the first SIM is in the RRC connected mode and a second SIM is in the RRC idle mode, receive information for a network of the second SIM; and
allocate a radio frequency (RF) and baseband resources from the first SIM to the second SIM.

13. The UE of claim 12, wherein the predefined criterion comprises expiry of an RF unavailability monitoring timer in the RRC connected mode.

14. The UE of claim 13, wherein the processor is configured to:
determine that the first SIM fails to receive the RF and baseband resources within the expiry of the RF unavailability monitoring timer; and
transmit the RRC connection release indication message.

15. The UE of claim 13, wherein the processor is further configured to set a value of the RF unavailability monitoring timer.

16. The UE of claim 13, wherein the processor is further configured to receive a value of the RF unavailability monitoring timer from the network.

17. The UE of claim 12, wherein the predefined criterion comprises downlink data reception inactivity for a preset time.

18. The UE of claim 17, wherein the processor is configured to receive an access message requesting access to the RF and the baseband resources from the second SIM, and
wherein the processor is configured to transmit the RRC connection release indication message comprises determining that the RRC connected mode of the first SIM is unknown to the network when downlink data reception is inactive for the preset time.

19. The UE of claim 12, wherein the predefined criterion comprises reception of a paging message from the network while the UE is in the RRC connected mode.

20. The UE of claim 19, wherein transmitting the RRC connection release indication message comprises determining that the RF and the baseband resources are to be allocated to the second SIM upon reception of the paging message, and transmitting the RRC connection release indication message upon determining that the RF and the baseband resources are to be allocated to the second SIM.
